(19) United States
(12) Patent Application Publication
(10) Pub. No.: US 2002/0108294 A1
(43) Pub. Date: Aug. 15, 2002

(54) Fishing line and lure connectors

(76) Inventor: Michael L. Denby, Scottsdale, AZ (US)

Correspondence Address: Michael W Gotry, Parsons & Goltry, 340 East Palm Lane, Suite 260, Phoenix, AZ, 85004, US

(21) Appl. No.: 09/546,502

(22) Filed: Apr. 11, 2000

(51) Int. Cl. A01K 91/00

(52) U.S. Cl. 43/43.12

(57) ABSTRACT

Apparatus for receiving and securing an end segment of a line, the end segment having an outer diameter, the apparatus comprising a receptacle including a chamber bound by a substantially continuous sidewall defining an inner diameter that is substantially equal to the outer diameter of the end segment and extensions extending into the chamber for impinging against the end segment.

### FIELD OF THE INVENTION

This invention relates to angling accessories and, more particularly, to connectors for securing lines and lures.

### BACKGROUND OF THE INVENTION

A fisherman is no better than his knots. It is no good to own the best tackle and have an abundance of fishing knowledge and skill if, when fish are hooked, knots give way. The angler must therefore pay close attention to his knots. Under most conditions, an angler needs to know how to tie only a few knots, which, for most fishermen, include the clinch knot for fastening lures to leaders and tippets, the blood knot for fastening tippets to leaders and the nail knot for fastening leaders to fly lines. On a windy day, a cold day when hands are cold and for the elderly fisherman who has lost dexterity in his hands, tying knots can prove difficult and frustrating. Although the well-traveled angler typically employs a vast arsenal of gadgets and accessories in practicing his art, needed is yet another to provide the angler with a way to easily fasten lures to leaders and tippets, tippets to leaders and leaders to fly lines.

Accordingly, it would be highly desirable to provide new and improved connectors for securing lines and lures.

It is another purpose of the invention to provide new and improved connectors that are easy to use.

It is still another purpose of the invention to provide new and improved connectors that are easy and inexpensive to construct.

It is a further provision of the invention to eliminate the need and difficulty of tying attachment knots.

It is still a further purpose of the invention to provide new and improved connectors that are strong, easy to install and transport, and highly efficient.

It is yet still a further purpose of the invention to increase the ease and efficiency of exchanging lures during fishing activity.

### SUMMARY OF THE INVENTION

The above problems and others are at least partially solved and the above purposes and others realized in new and improved connectors for securing lines and lures. In one embodiment, provided is a connector for receiving and securing an end segment of a line. The end segment defines an outer diameter. The connector is comprised of a receptacle including a chamber bound by a substantially continuous sidewall defining an inner diameter that is substantially equal to the outer diameter of the end segment of the line. The connector supports extensions or teeth which extend into the chamber for impinging against the end segment. The receptacle is resilient and deformable, and the extensions are positioned at spaced intervals along substantially the entire length of the chamber. The extensions are directed away from an open end of the receptacle which leads to the chamber for providing a maximum engagement. The receptacle supports a coupler or line, which are each capable of engaging and supporting a lure. In accordance with another embodiment of the invention, receptacle may be supported by or formed at or into at least one of the opposing ends of a length of line, such as the butt end of a leader.

In another embodiment of the invention, provided is a connector for coupling a first end segment of a first line and a second end segment of a second line. The first and second end segments each define an outer diameter. In this embodiment, the connector is comprised of a body including a first receptacle for receiving and securing one of the first and second end segments and an opposing receptacle for receiving and securing the other of the first and second end segments. The first receptacle includes a first chamber bound by a substantially continuous sidewall defining an inner diameter that is substantially equal to the outer diameter of the one of the first and second end segments. The first receptacle supports first extensions or teeth which extend into the first chamber for impinging against the one of the first and second end segments. The second receptacle includes a second chamber bound by a substantially continuous sidewall defining an inner diameter that is substantially equal to the outer diameter of the other of the first and second end segments. The second receptacle supports second extensions or teeth which extend into the second chamber for impinging against the other of the first and second end segments. The body is resilient and deformable. The first chamber includes a length, and the first extensions extend into the first chamber at spaced intervals along substantially the entire length of the first chamber, and are directed away form an opening leading to the first chamber. The second chamber also includes a length, and the second extensions extend into the second chamber at spaced intervals along substantially the entire length of the second chamber, and are directed away from an opening leading to the second chamber.

In accordance with yet another embodiment, provided is a connector for receiving and securing an end segment of a line. The end segment includes an outer diameter and the connector is comprised of a receptacle including a chamber bound by a substantially continuous sidewall defining an inner diameter. The connector is resilient and deformable between shortened and lengthened conditions. The connector is constructed and arranged such that the inner diameter is maximized in the shortened condition and minimized in the lengthened condition. The receptacle supports a biasing element or framework which biases the receptacle into the lengthened condition. The biasing element also which facilitates the minimum and maximum inner diameters of the receptacle when the connector is moved into and between the shortened and lengthened conditions. The inner diameter of the receptacle in the shortened condition is greater than the outer diameter of the end segment, and the inner diameter of the receptacle in the lengthened condition is less than or at least substantially equal to the outer diameter of the end segment. The receptacle of this embodiment may be provided with extensions or teeth extending into the chamber for impinging against the end segment. If provided, the extensions should preferably extend into the chamber at spaced intervals along substantially the entire length of the chamber, and point away from an opening of the receptacle leading to the chamber. The receptacle supports a coupler or line which are each capable of engaging and supporting a lure. In accordance with the invention, the receptacle may be supported by or formed at or into at least one of the opposing ends of a length of line, such as the butt end of a leader.

In accordance with yet another embodiment of the invention, provided is a coupler for coupling a first end segment of a first line and a second end segment of a second line. The first and second end segments each have an outer diameter. In this embodiment, the coupler is comprised of a body including a first receptacle for receiving and securing one of the first and second end segments and an opposing receptacle for receiving and securing the other of the first and second end segments. The first receptacle includes a first chamber bound by a substantially continuous sidewall which defines an inner diameter. The first receptacle is resilient and deformable between shortened and lengthened conditions. The body is constructed and arranged such that the inner diameter is maximized in the shortened condition and minimized in the lengthened condition. The first receptacle supports a first biasing element or framework for biasing the first receptacle into the lengthened condition. The first biasing element also facilitates the minimum and maximum inner diameters of the first receptacle when the first receptacle is moved into and between the shortened and lengthened conditions. The inner diameter of the first receptacle in the shortened condition is greater than the outer diameter of the one of the first and second end segments, and the inner diameter of the first receptacle in the lengthened condition is less than or at least substantially equal to the outer diameter of the one of the first and second end segments. The second receptacle includes a second chamber bound by a substantially continuous sidewall defining an inner diameter that is substantially equal to the outer diameter of the other of the first and second end segments. The second receptacle deformable between shortened and lengthened conditions. The body is constructed and arranged such that the inner diameter of the second receptacle is maximized in the shortened condition and minimized in the lengthened condition. The second receptacle supports a second biasing element or framework for biasing the second receptacle into the lengthened condition. The second biasing element also facilitates the minimum and maximum inner diameters of the second receptacle when the second receptacle is moved into and between the shortened and lengthened conditions. The inner diameter of the second receptacle in the shortened condition is greater than the outer diameter of the other of the first and second end segments, and the inner diameter of the second receptacle in the lengthened condition is less than or at least substantially equal to the outer diameter of the other of the first and second end segments.

The first and second biasing elements are preferably integrally formed with the first and second receptacles, respectively. The first receptacle may be equipped with first extensions or teeth extending into the first chamber for impinging against the one of the first and second end segments. If provided, the first extensions or teeth preferably extend into the first chamber at spaced intervals along substantially the entire length of the first chamber and away from an opening leading to the first chamber. The second receptacle may be equipped with second extensions or teeth extending into the second chamber for impinging against the other of the first and second end segments. If provided, the second extensions or teeth preferably extend into the second chamber at spaced intervals along substantially the entire length of the second chamber and away from an opening leading to the second chamber.

### BRIEF DESCRIPTION OF THE DRAWINGS

The foregoing and further and more specific objects and advantages of the invention will become readily apparent to those skilled in the art from the following detailed description taken in conjunction with the drawings in which:

FIG. 1 illustrates a connector coupling a lure to a line, the connector being shown as it would appear in use by an angler;

FIG. 2 is an enlarged perspective view of the connector of FIG. 1;

FIG. 3 is a sectional view taken along line 3-3 of FIG. 2;

FIG. 3A is a view very similar to the view of FIG. 3, with the connector shown as it would appear securing a line;

FIG. 4 is a front view of the connector of FIG. 2;

FIG. 5 is a perspective view of another embodiment of a connector for coupling a lure to a line;

FIG. 5A is a sectional view taken along line 5A-5A of FIG. 5;

FIG. 6 is a front view of the connector of FIG. 5;

FIG. 7 is a perspective view of yet another embodiment of a connector for coupling a lure to a line;

FIG. 8 is a sectional view taken along line 8-8 of FIG. 7;

FIG. 9 is a perspective view of a length of line constructed in accordance with the invention;

FIG. 10 is a sectional view taken along line 10-10 of FIG. 9;

FIG. 11 is a perspective view of a connector for securing two lines;

FIG. 12 is a sectional view taken along line 12-12 of FIG. 11;

FIG. 12A is a view very similar to the view of FIG. 12, with the connector shown as it would appear securing two lines;

FIG. 13 is a perspective view of yet still another embodiment of a connector for connecting a lure to a line;

FIG. 14 is a sectional view taken along line 14-14 of FIG. 13;

FIG. 15 is a view very similar to the view of FIG. 14, with the connector as it would appear receiving a line; and

FIG. 16 is a view very similar to the view of FIG. 15, with the connector shown as it would appear securing a line.

### DETAILED DESCRIPTION OF A PREFERRED EMBODIMENT

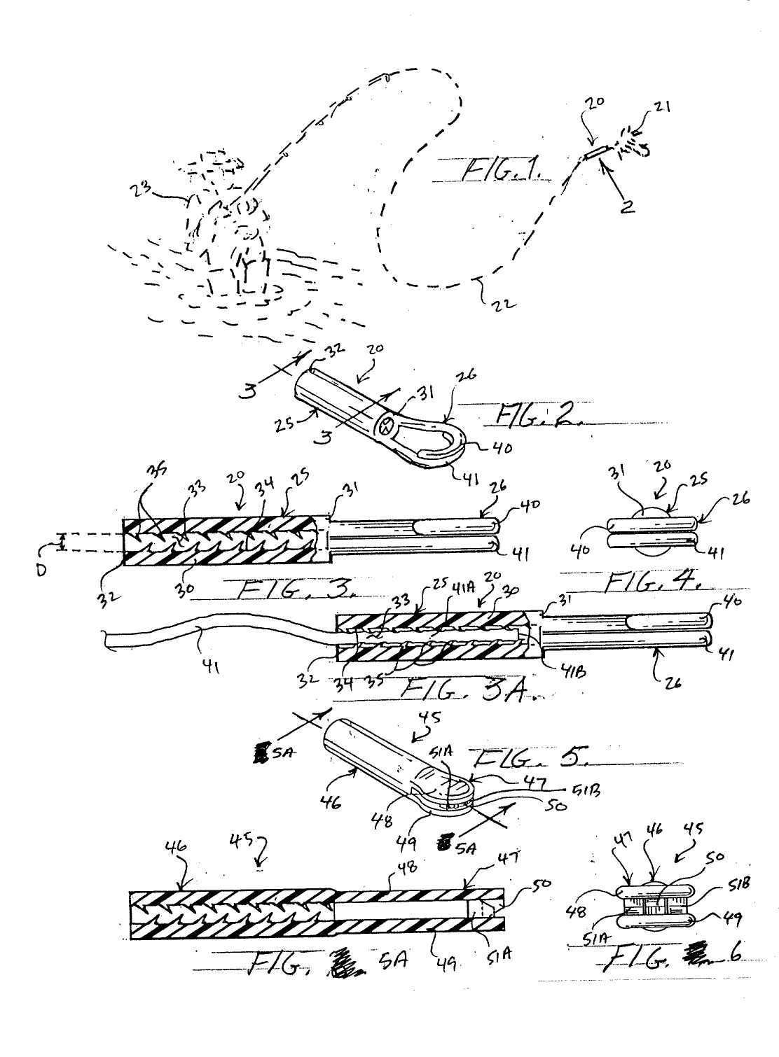

Turning to the drawings, in which like reference characters indicate corresponding elements throughout the several views, attention is first directed to FIG. 1, which illustrates a connector 20 for coupling a lure 21 to a line 22 (shown in phantom line). Connector 20 is shown in FIG. 1 being employed by an angler 23 shown in phantom outline. Regarding FIG. 2, connector 20 is constructed of or formed from nylon or other similarly resilient, strong and deformable material, and is comprised of a receptacle 25 and a coupler 26. Turning to FIG. 3, receptacle 25 is elongate and includes a continuous sidewall 30 having opposing ends 31 and 32. End 32 is open and leads to a chamber 33 bound by sidewall 30. End 31 is preferably closed, but it may be open if so desired so as to communicate with chamber 33. Chamber 33 is elongate and defined by a continuous inner surface 34 of sidewall 30. Surface 34 defines an inner diameter D of chamber 33 that is substantially constant along substantially the entire length of chamber 33 from end 32 to end 31. Protrusions, extensions or teeth 35 extend into chamber 33 from inner surface 34 and are positioned at spaced intervals along substantially the entire length of chamber 33 from end 32 to end 31. Teeth 35 are flexible and resilient, preferably molded, formed or integral with sidewall 30, and face away from end 32.

Regarding FIG. 3A, receptacle 25 is designed to receive and secure an end segment 41A of a line 41. In this example, line 41 is a fishing line such as a tippet or leader formed of nylon monofilament, and end segment 41A is a length of line 41 leading to its free end 41B. Inner diameter D of chamber 33 is substantially equal to the outer diameter of end segment 41A. To install connector 20, connector 20 is held and end 41B forced into chamber 33 through end 32. Because teeth 35 are slanted or directed away from open end 32, flexible and resilient, chamber 33 readily accepts end segment 41A without considerable effort or difficulty. When installed in chamber 33, it is preferred that free end 41B reside against or immediately adjacent end 31 of receptacle 25.

Because inner diameter D of chamber is substantially constant from end 32 to end 31 of receptacle 25 and substantially equal to the outer diameter of end segment 41B, the fit of end segment 41A against inner surface 34 of chamber 33 is tight, snug or close. This forces teeth 35 to impinge against end segment 41A. In FIG. 3A, an exaggerated space is shown between end segment 41A and inner surface 34 of chamber 33 for ease of illustration. The slanted orientation of teeth 35 away from end 32, the snug fit of end segment 41A in chamber 33 and the impingement of teeth 35 against end segment 41A cooperate to grippingly seize or secure end segment 41A in place, and inhibits end segment 41A from dislodging from chamber 33 through open end 32 while under a pulling force. Although teeth 35 are flexible and resilient, the snug fit between inner surface 34 and end segment 41A prevents teeth 35 from buckling under force and compels them to impinge against end segment 41A, which provides a surprisingly strong and highly effective coupling.

Most fisherman use fishing lines with outer diameters that range from 0.004 to 0.021 of an inch. Smaller and larger sizes can, however, be found. Depending on the needs of the angler and the fishing line he is using, receptacle 25 is preferably from 0.5-8.0 cm in length and 1-10 mm in outer diameter, with the thickness of sidewall 30 falling from 0.5-4.0 mm. However, receptacle 25 may incorporate any suitable or desired dimensions consistent with the teachings of this disclosure.

With regard to FIGS. 2 and 3, coupler 26 is supported by and extends away from end 31 of receptacle 25, and is designed to engage the hook eye of a lure, obviating the need to tie a clinch knot, a Turle knot, a Homer Rhode loop knot, end-loop knot or other suitable lure-to-line connection knot. In this embodiment, coupler 26 is comprised of a pair of resilient hooks 40 and 41, which extend away from end 31 and engage one another in an overlapping state (see FIG. 4) forming a continuous loop. Hooks 40 and 41 are substantially coextensive, biased together, and may made of the same material as receptacle 25 or a different material. A lure is engagable to coupler 26 by forcing hooks 40 and 41 apart and threading the free end of one of the hooks 40 and 41 into and through the hook eye of the lure. The engagement of hooks 40 and 41 in the overlapping state prevents the attached lure from falling off. Hooks 40 and 41 are constructed of a size that will permit the overlapping portions to readily pass through the hook eye of the lure. To remove the lure, the foregoing operation need only be reversed.

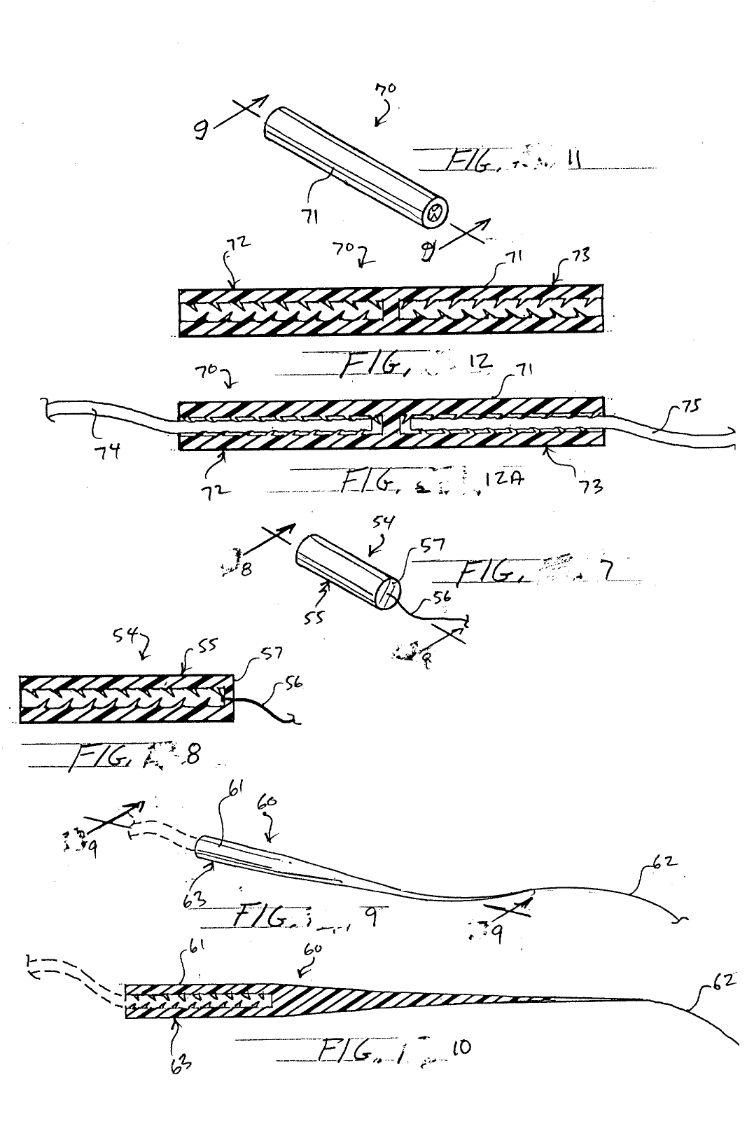

The coupler of the invention may be provided in many forms suitable for permitting engagement to the hook eye of a lure. As a matter of example FIGS. 5, 5A and 6 illustrate another embodiment of a connector 45, which is comprised of a receptacle 46 and another embodiment of a coupler 47. Receptacle 46 incorporates the same structural features as receptacle 25. Accordingly, details of receptacle 46 will not be discussed. Coupler 47 is comprised of a pair of resilient plates 48 and 49, which extend away from the closed end of receptacle 46 in an overlapping state. Plates 48 and 49 are substantially coextensive, biased together and made of the same material as receptacle 46. Plate 48 carries a prong 50, which resides between a pair of prongs 51A and 51B carried by plate 49. Prongs 50, 51A and 51B cooperate together to hold or clutch the hook eye of a lure when it is slipped between plates 48 and 49. To facilitate easy insertion of the hook eye between plates 48 and 49, prongs 50, 51A and 51B are outwardly beveled. To remove the lure, a user need only grasp lure, twist it to forcefully separate plates 48 and 49 and then move the lure away.

Turning now to FIGS. 7 and 8, shown is a connector 54 constructed in accordance with yet another embodiment of the invention. Connector 54 is comprised of a receptacle 55 and a line 56. Receptacle 54 incorporates the same structural features as receptacle 25 discussed previously. Accordingly, details of receptacle 54 will not be discussed. Line 56 is formed with and extends from end 57 of receptacle 54. In this embodiment, end 57 is closed. It is intended that line 57 comprise tippet of a specified length and having a free end available for tying to a lure in a conventional manner. In this embodiment, receptacle 54 is designed to engage the end of a leader, obviating the need to tie a blood knot or other suitable line-to-line connection knot.

Regarding FIGS. 9 and 10, shown is a length of line 60 constructed in accordance with the invention. Line 60 is elongate, includes opposing ends 61 and 62, and is constructed or formed of a resilient, strong and deformable material such as nylon or other suitable material. In this embodiment, line 60 is shown in the form of a tapered leader, with end 61 comprising the butt end and end 62 comprising the tail end. Line 60 can comprise a level leader if so desired. Formed into end end 61 is a receptacle 63, which incorporates the same structural features as receptacle 25. Accordingly, details of receptacle 63 will not be discussed. In this embodiment, line 60 is designed to function as the nearly invisible connection between a lure and, for instance, a fly line or other form of fishing line. Receptacle 63 secures an end segment of the fly line, which obviates the need to tie a nail knot or other suitable leader-to-fly line connection knot.

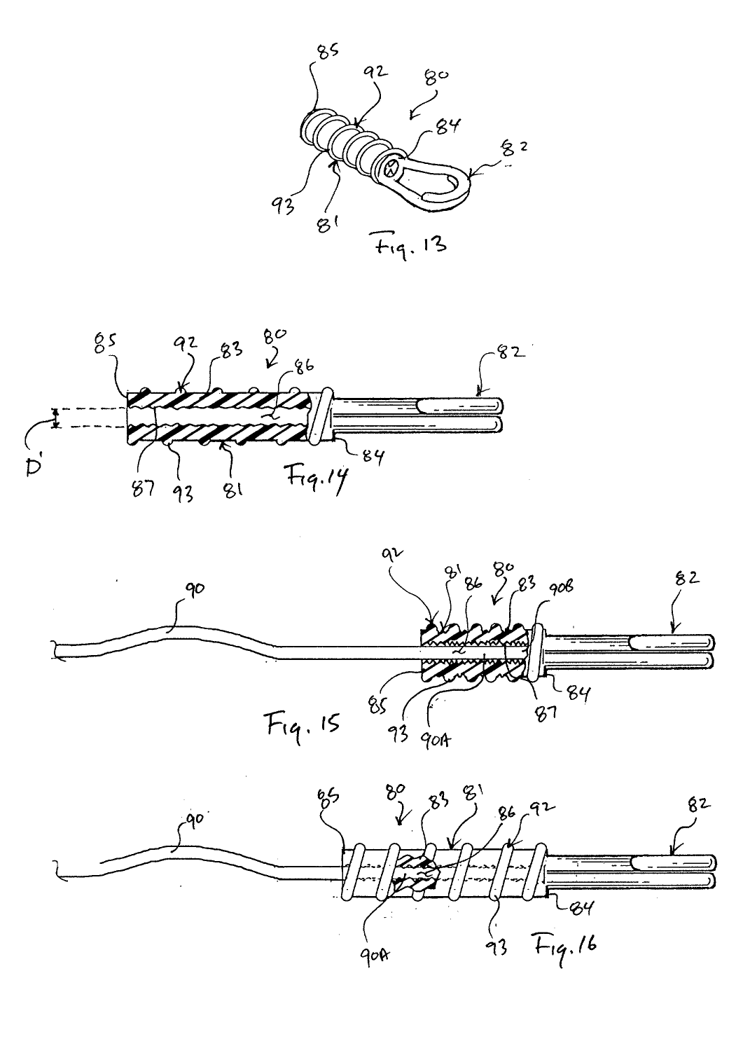

Attention is now directed to FIGS. 11, 12 and 12A, which illustrate a connector 70 for securing two lines such as a fly line and a leader or a leader and tippet, and for securing together monofilament of different diameters. In this embodiment, connector 70 is comprised of an elongate body or sleeve 71 having opposing receptacles 72 and 73 on either side of sleeve 71. Receptacles 72 and 73 each incorporate the same structural features as receptacle 25. Accordingly, details of receptacles 72 and 73 will not be discussed. However, in this embodiment the closed ends of receptacles 72 and 73 face one another and the open ends of receptacles 72 and 73 face away from one another. The axes defined by receptacles 72 and 73 are substantially common as clearly shown in FIGS. 12 and 12A. FIG. 12 shows two lines 74 and 75 each shown as they would appear secured to receptacles 72 and 73, respectively. The diameters of receptacles 72 and 73 may be substantially the same for facilitating a coupling between lines having substantially identical diameters, or different for facilitating a coupling between lines having different diameters. Body 71 is preferably molded or otherwise integrally formed of a resilient, strong and deformable material such as nylon or other suitable material, and obviates the need for an angler to tie a blood knot, surgeon's knot, shocker knot or other suitable line-to-line connection knot.

Turning now to FIGS. 13-16, illustrated is still another embodiment of a connector 80 for connecting a lure to a line. Connector 80 is constructed of or formed from nylon or other similarly resilient, strong and deformable material, and is comprised of a receptacle 81 and a coupler 82. As best shown in FIG. 14, receptacle 81 is elongate and includes a continuous sidewall 83 having opposing ends 84 and 85. End 85 is open and leads to a chamber 86 bound by sidewall 83. End 84 is preferably closed, but it may be open if so desired. Chamber 86 is elongate and defined by a continuous inner surface 87 of sidewall 83. Surface 87 defines an inner diameter D′ of chamber 86 that is substantially constant along substantially the entire length of chamber 86 from end 85 to end 84. Although not shown, protrusions, extensions or teeth may be provided to extend into chamber 86 from inner surface 87 at spaced intervals along substantially the entire length of the chamber 86 from end 85 to end 84. If provided, these teeth 35 are preferably flexible and resilient, molded, formed or integral with sidewall 83, and face away from end 85. Coupler 82 may comprise the structure of coupler 26 discussed previously in connection with connector 20 or coupler 47 discussed previously in connection with connector 45. In lieu of coupler 82, a line may be used, much like line 56 discussed previously in connection with coupler 54.

Receptacle 81 is deformable between a shortened condition shown in FIG. 15 and a lengthened condition shown in FIGS. 13, 14 and 15. Receptacle 81 supports or is otherwise equipped with a biasing element or framework 92, which is constructed and arranged for biasing receptacle 81 into the lengthened condition and for resisting the movement of receptacle 81 into the shortened condition. Biasing element 92 may comprise a discrete device that fastened or otherwise coupled to receptacle 81 or, in regards to a preferred embodiment, formed or molded integral with receptacle 81 as substantially shown. In this embodiment, biasing element 92 is comprised of a spring 93, which has the form of a coiled element or framework much like a conventional compression spring. However, biasing element 92 may comprise ribbing or other framework construction suitable for biasing receptacle 81 into the lengthened condition. Due to the resiliency and deformability of receptacle 81, spring 93 is constructed and arranged in such a way that it causes inner diameter D′ of receptacle 81 to increase or maximize in the shortened condition of receptacle 81 and decrease or minimize in the lengthened condition of receptacle 81. Consistent with this disclosure, biasing element 92 may be provided as a framework of any appropriate structure capable of carrying the same function as spring 93.

Receptacle 81 is designed to receive and secure an end segment 90A of a line 90. In this example, line 90 is a fishing line such as a tippet or leader formed of nylon monofilament, and end segment 90A is a length of line 90 leading to its free end 90B. When receptacle 81 is in the lengthened condition, inner diameter D′ of chamber 86 is less than or at least substantially equal to the outer diameter of end segment 90A. When receptacle 81 is in the shortened condition, inner diameter D′ of chamber 86 is greater than the outer diameter of end segment 90A.

To install connector 80, connector 80 is held and end 90B forced into chamber 86 from end 85. The bias of spring 93 may be overcome in response to a sufficient force exerted in the act of forcing end 90B of line 90 into and through end 85. This causes receptacle 81 to move into the shortened condition, which increases inner diameter D′ and allows end 90B to pass into chamber 86 through end 85 as shown substantially in FIG. 15. When end segment 90A is properly inserted into chamber 86, spring 93 biases receptacle 81 into the extended condition as shown substantially in FIG. 16, which causes inner diameter D′ to decrease or otherwise move into or near its minimized condition which causes inner surface 87 to frictionally grip, seize or clutch end segment 90A. This frictional seizing of end segment 90A is sufficient to provide a strong, efficient coupling between receptacle 81 and line 90, which inhibits end segment 90A from dislodging from chamber 86 through end 85 while under a pulling force. When end segment 91A is installed into chamber 86 in this manner, it is preferred that end 90B reside against or immediately adjacent end 84 of receptacle 81. To enhance the coupling between receptacle and end segment 90A, inner surface 87 be textured as generally shown in FIG. 14 or provided with teeth as discussed above.

In view of this disclosure, the skilled artisan will readily appreciate that receptacle 81 may be formed at or into the butt end of a leader much like leader 60 previously discussed in combination with FIGS. 9 and 10, and that two receptacles 81 may be formed into a connector for connecting two lines together like connector 70 previously discussed in combination with FIGS. 11, 12, and 12A. Also, each connector discussed in this specification may be rated or otherwise constructed to withstand the same pressure or pounds as a corresponding fishing line so as to give only when the corresponding fishing line itself would have given. When a coupler or an attached line breaks, the angler need only clip the line to form a clean free end and then attach a desired coupler consistent with the teachings of this disclosure.

The invention has been described above with reference to one or more preferred embodiments. However, those skilled in the art will recognize that changes and modifications may be made in the described embodiments without departing from the nature and scope of the invention. Various changes and modifications to one or more of the embodiments herein chosen for purposes of illustration will readily occur to those skilled in the art. To the extent that such modifications and variations do not depart from the spirit of the invention, they are intended to be included within the scope thereof, which is assessed only by a fair interpretation of the following claims.

Having fully described the invention in such clear and concise terms as to enable those skilled in the art to understand and practice the same, the invention claimed is:

1. Apparatus for receiving and securing an end segment of a line, the end segment having an outer diameter, the apparatus comprising a receptacle including a chamber bound by a substantially continuous sidewall defining an inner diameter that is substantially equal to the outer diameter of the end segment and extensions extending into the chamber for impinging against the end segment.

2. Apparatus of claim 1, the chamber having a length, wherein the extensions are positioned at spaced intervals along substantially the entire length of the chamber.

3. Apparatus of claim 1, wherein the extensions are directed away from an open end of the receptacle which leads to the chamber.

4. Apparatus of claim 1, wherein the receptacle supports means for engaging and supporting a lure.

5. Apparatus of claim 4, wherein the means comprises a line.

6. Apparatus of claim 4, wherein the means comprises a coupler.

7. Apparatus for coupling a first end segment of a first line having an outer diameter and a second end segment of a second line having an outer diameter, the apparatus comprising:
a body including a first receptacle for receiving and securing one of the first and second end segments and an opposing receptacle for receiving and securing the other of the first and second end segments;
the first receptacle including a first chamber bound by a substantially continuous sidewall defining an inner diameter that is substantially equal to the outer diameter of the one of the first and second end segments and first extensions extending into the first chamber for impinging against the one of the first and second end segments; and
the second receptacle including a second chamber bound by a substantially continuous sidewall defining an inner diameter that is substantially equal to the outer diameter of the other of the first and second end segments and second extensions extending into the second chamber for impinging against the other of the first and second end segments.

8. Apparatus of claim 7, the first chamber including a length, wherein the first extensions extend into the first chamber at spaced intervals along substantially the entire length of the first chamber.

9. Apparatus of claim 7, the second chamber including a length, wherein the second extensions extend into the second chamber at spaced intervals along substantially the entire length of the second chamber.

10. Apparatus of claim 7, wherein the first extensions are directed away from an open end of the first receptacle which leads to the first chamber.

11. Apparatus of claim 7, wherein the second extensions are directed away from an open end of the second receptacle which leads to the second chamber.

12. Apparatus for receiving and securing an end segment of a line, the end segment having an outer diameter, the apparatus comprising:
a receptacle including a chamber bound by a substantially continuous sidewall defining an inner diameter;
the receptacle deformable between shortened and lengthened conditions, the inner diameter being greater than the outer diameter of the end segment in the shortened condition of the receptacle and at least substantially equal to the outer diameter of the end segment in the lengthened condition of the receptacle; and
a biasing element supported by the receptacle for biasing the receptacle into the lengthened condition.

13. Apparatus of claim 12, wherein the biasing element is integral with the receptacle.

14. Apparatus of claim 12, wherein the receptacle supports extensions extending into the chamber for impinging against the end segment.

15. Apparatus of claim 14, the chamber including a length, wherein the extensions extend into the chamber at spaced intervals along substantially the entire length of the chamber.

16. Apparatus of claim 14, wherein the extensions are directed away from an open end of the receptacle which leads to the chamber.

17. Apparatus of claim 12, wherein the receptacle supports means for engaging a lure.

18. Apparatus of claim 17, wherein the means for engaging comprises a line.

19. Apparatus of claim 17, wherein the means for engaging comprises a coupler.

20. Apparatus for coupling a first end segment of a first line and a second end segment of a second line, the first and second end segments each having an outer diameter, the apparatus comprising:
a body including a first receptacle for receiving and securing one of the first and second end segments and an opposing receptacle for receiving and securing the other of the first and second end segments;
the first receptacle including:
a first chamber bound by a substantially continuous sidewall defining an inner diameter,
the first receptacle deformable between a shortened condition and a lengthened condition, the inner diameter of the first receptacle being greater than the outer diameter of the one of the first and second end segments in the shortened condition of the first receptacle and at least substantially equal to the outer diameter of the one of the first and second end segments in the lengthened condition of the first receptacle, and
a first biasing element supported by the first receptacle for biasing the first receptacle into the lengthened condition; and
the second receptacle including:
a second chamber bound by a substantially continuous sidewall defining an inner diameter,
the second receptacle deformable between a shortened condition and a lengthened condition, the inner diameter of the second receptacle being greater than the outer diameter of the other of the first and second end segments in the shortened condition of the second receptacle and at least substantially equal to the outer diameter of the other of the first and second end segments in the lengthened condition of the second receptacle, and
a second biasing element supported by the second receptacle for biasing the second receptacle into the lengthened condition.

21. Apparatus of claim 20, wherein the first biasing element is integral with the first receptacle.

22. Apparatus of claim 20, wherein the first receptacle supports first extensions extending into the first chamber for impinging against the one of the first and second end segments.

23. Apparatus of claim 22, the first chamber including a length, wherein the first extensions extend into the first chamber at spaced intervals along substantially the entire length of the first chamber.

24. Apparatus of claim 22, wherein the first extensions are directed away from an open end of the first receptacle which leads to the first chamber.

25. Apparatus of claim 20, wherein the second biasing element is integral with the second receptacle.

26. Apparatus of claim 20, wherein the second receptacle supports extensions extending into the second chamber for impinging against the other of the first and second end segments.

27. Apparatus of claim 26, the second chamber including a length, wherein the extensions extend into the second chamber at spaced intervals along substantially the entire length of the second chamber.

28. Apparatus of claim 26, wherein the extensions are directed away from an open end of the second receptacle which leads to the second chamber.

29. Apparatus comprising:
a length of line having opposing ends;
a receptacle supported by one of the opposing ends for receiving and securing an end segment of a fishing line, the end segment having an outer diameter;
the receptacle including a chamber bound by a substantially continuous sidewall defining an inner diameter that is substantially equal to the outer diameter of the end segment and extensions extending into the chamber for impinging against the end segment.

30. Apparatus of claim 29, the chamber having a length, wherein the extensions are positioned at spaced intervals along substantially the entire length of the chamber.

31. Apparatus of claim 29, wherein the extensions are directed away from an open end of the receptacle which leads to the chamber.

32. Apparatus comprising:
a length of line having opposing ends;
a receptacle supported by one of the opposing ends for receiving and securing an end segment of a fishing line, the end segment having an outer diameter;
the receptacle including a chamber bound by a substantially continuous sidewall defining an inner diameter;
the receptacle deformable between shortened and lengthened conditions, the inner diameter being greater than the outer diameter of the end segment in the shortened condition of the receptacle and at least substantially equal to the outer diameter of the end segment in the lengthened condition of the receptacle; and
a biasing element supported by the receptacle for biasing the receptacle into the lengthened condition.

33. Apparatus of claim 32, wherein the biasing element is integral with the receptacle.

34. Apparatus of claim 32, wherein the receptacle supports extensions extending into the chamber for impinging against the end segment.

35. Apparatus of claim 34, the chamber including a length, wherein the extensions extend into the chamber at spaced intervals along substantially the entire length of the chamber.

36. Apparatus of claim 34, wherein the extensions are directed away from an open end of the receptacle which leads to the chamber.
